(19) United States
(12) Patent Application Publication
(10) Pub. No.: US 2016/0081019 A1
(43) Pub. Date: Mar. 17, 2016

(54) METHOD AND APPARATUS TO REDUCE POWER CONSUMPTION IN WIRELESS DEVICES

(71) Applicant: QUALCOMM Incorporated, San Diego, CA (US)

(72) Inventors: Sunit Pujari, Hyderabad (IN); Hemant Kumar Sahoo, Hyderabad (IN); Imran Ansari, Hyderabad (IN); Sougat Ray, Rourkela (IN); Rohit Singh, Hyderabad (IN); Bhasker Neti, Hyderabad (IN); Ajay Kumar Gaja, Hyderabad (IN)

(21) Appl. No.: 14/485,138

(22) Filed: Sep. 12, 2014

(51) Int. Cl. H04W 52/02; H04W 4/00

(52) U.S. Cl. CPC H04W 52/0209; H04W 4/008; H04W 84/12

(57) ABSTRACT

A method and apparatus are disclosed for reducing power consumption of wireless devices operating in a wireless network. In one embodiment, a first wireless device may operate in low-power mode and receive a BLUETOOTH low energy (BLE) message from a second wireless device. The first wireless device may leave the low-power mode and enter a normal operating mode based, at least in part, on the BLE message. In some embodiments, the BLE message may include informational elements that the first wireless device may use to determine whether to remain in or leave the low-power mode. In some other embodiments, the BLE message may be synchronized to a Wi-Fi message, such as a Wi-Fi beacon. In at least one embodiment, the first wireless device may stop scanning for wireless networks when in the low-power mode.

### TECHNICAL FIELD

The present embodiments relate generally to wireless devices, and specifically to reducing power consumption in wireless devices.

### BACKGROUND OF RELATED ART

A wireless network may include two or more wireless devices. The wireless network may be operating in an infrastructure mode and may be administered by an access point, or may be operating in an ad hoc or peer-to-peer mode and may be administered by one or more group owners.

Connecting to and/or administering the wireless network consumes power, even during times when there is little or no network activity. For example, access points and peer-to-peer group owners may periodically send (e.g., broadcast) a Wi-Fi beacon during each beacon period. Sending the Wi-Fi beacon and actively listening for any Wi-Fi messages in response to the Wi-Fi beacon consumes power, even when there are no Wi-Fi messages to receive. When the wireless device is a mobile wireless device, power consumption may undesirably decrease battery life.

Thus, there is a need to reduce the power consumption of wireless devices, particularly when there is little or no network traffic in the wireless network.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Devices and methods for reducing power consumption by a wireless device are disclosed. In accordance with the present embodiments, a first wireless device may receive a Wi-Fi message by establishing a BLUETOOTH low energy (BLE) connection between the first wireless device and a second wireless device. The first wireless device may operate in a low-power mode and may receive a BLE message from the second wireless device. The first wireless device may leave the low-power mode and enter a normal operating mode based, at least in part, on the received BLE message. The first wireless device may then receive the Wi-Fi message from the second wireless device.

In other embodiments, a first wireless device may scan for a Wi-Fi network by establishing a BLUETOOTH low energy (BLE) connection between the first wireless device and a second wireless device. The first wireless device may operate in a low-power mode and may receive a BLE message from the second wireless device. The first wireless device may leave the low-power mode and enter a normal operating mode based, at least in part, on the received BLE message. The first wireless device may then scan for the Wi-Fi network.

In still other embodiments, a first wireless device may establish a BLUETOOTH low energy (BLE) connection between the first wireless device and a second wireless device. An association database may be maintained at the first wireless device. A synchronized BLE message may be sent to the second wireless device based, at least in part, on the association database. For at least one embodiment, the association database may include at least one of a station association identification number, a station internet protocol address and a BLUETOOTH identification number associated with the second wireless device.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 depicts an example wireless network within which the present embodiments may be implemented.

FIG. 2 shows a wireless device that is one embodiment of the access point/peer-to-peer group owner and/or the station/peer-to-peer client of FIG. 1.

FIG. 3 shows a wireless device that is another embodiment of the access point/peer-to-peer group owner and/or the station/peer-to-peer client of FIG. 1.

FIG. 4 shows an illustrative flow chart depicting an example operation for operating the wireless network of FIG. 1, in accordance with some embodiments.

FIG. 5 shows an illustrative flow chart depicting another example operation for operating the wireless network of FIG. 1, in accordance with some embodiments.

FIG. 6 shows an illustrative flow chart depicting yet another example operation for operating the wireless network of FIG. 1, in accordance with some embodiments.

### DETAILED DESCRIPTION

The present embodiments are described below in the context of Wi-Fi enabled devices for simplicity only. It is to be understood that the present embodiments are equally applicable for devices using signals of other various wireless standards or protocols. As used herein, the terms “wireless local area network (WLAN)” and “Wi-Fi” can include communications governed by the IEEE 802.11 standards, BLUETOOTH®, HiperLAN (a set of wireless standards, comparable to the IEEE 802.11 standards, used primarily in Europe), and other technologies used in wireless communications. Further, the terms “low-power mode” may refer to a low-power operating mode in which one or more components of a Wi-Fi device or station are deactivated (e.g., to prolong battery life), and thus the terms “low-power state” and “power save state” may be used interchangeably herein.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

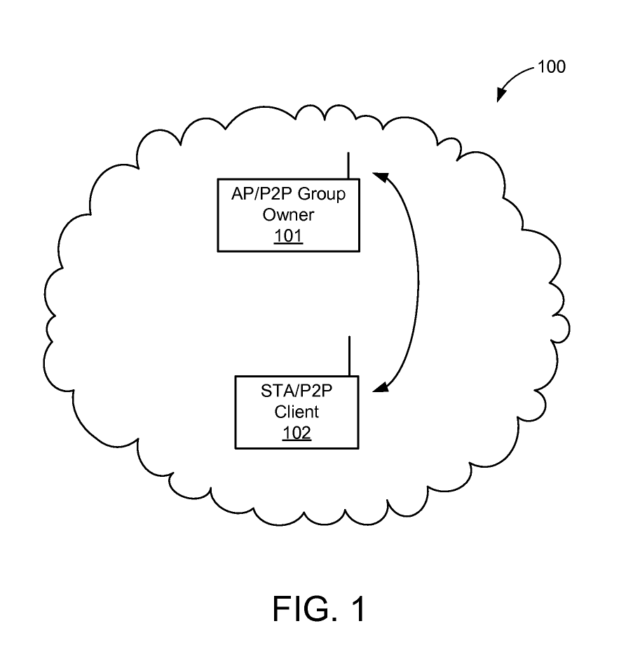

FIG. 1 depicts an example wireless network 100 within which the present embodiments may be implemented. Wireless network 100 may operate in an infrastructure mode or in an ad hoc (e.g., peer-to-peer and/or Wi-Fi direct) mode. As shown, example wireless network 100 includes two wireless devices 101 and 102. In other embodiments, wireless network 100 may include other numbers of wireless devices. Wireless devices 101 and 102 may include Wi-Fi transceivers (not shown for simplicity) to send and receive Wi-Fi messages.

In some embodiments, wireless network 100 may include a wireless device operating as an access point (AP) for wireless networks operating in the infrastructure mode, or as a peer-to-peer group owner (P2PGO) for wireless networks operating in the ad hoc or the peer-to-peer mode. The AP or P2PGO (shown as AP/P2P Group Owner 101 in FIG. 1) may provide network administrator functionality for wireless network 100. In some embodiments, the network administrator may be responsible for network administrative functions such as, but not limited to, joining the network, verifying network device credentials, forwarding network messages to other networks, and Wi-Fi beacon formation.

Wireless network 100 may include a wireless device operating as a station (STA) for wireless networks operating in the infrastructure mode, or as a peer-to-peer client (P2P client) for wireless networks operating in the ad hoc or the peer-to-peer mode. The STA or P2P client (shown as STA/P2P client 102 in FIG. 1) may exchange Wi-Fi messages with AP/P2PGO 101.

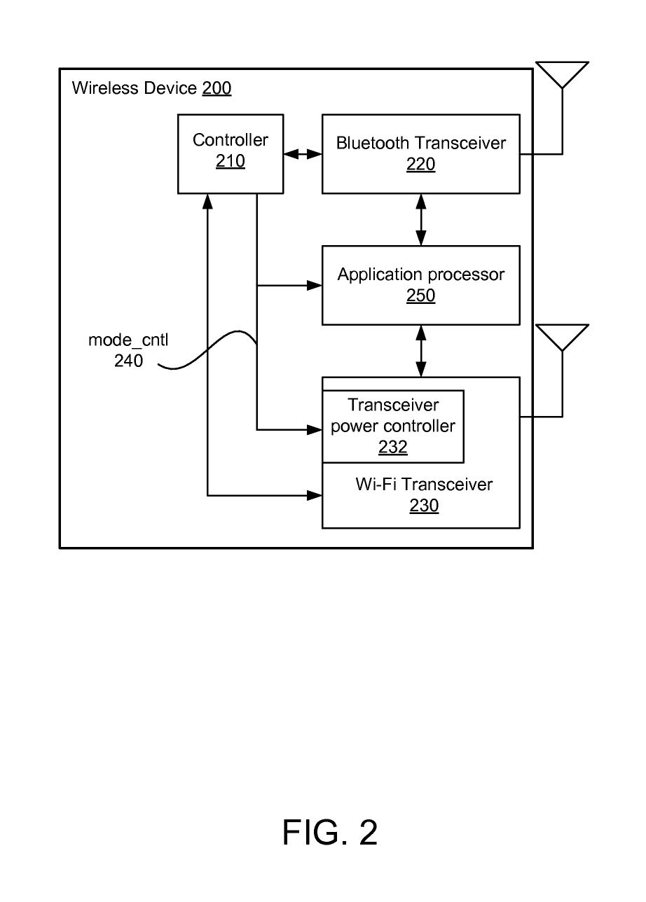

AP/P2PGO 101 and STA/P2P client 102 may also include BLUETOOTH® transceivers (not shown for simplicity) to send and receive BLUETOOTH messages. In some embodiments, the BLUETOOTH transceivers may also send and receive BLUETOOTH Low Energy (BLE) messages. Operation of AP/P2PGO 101 and STA/P2P client 102 with respect to BLE messages is described in more detail below in conjunction with FIGS. 2-6.

FIG. 2 shows a wireless device 200 that is one embodiment of AP/P2PGO 101 and/or STA/P2P client 102 of FIG. 1. Wireless device 200 includes a controller 210, a BLUETOOTH transceiver 220, a Wi-Fi transceiver 230 and an application processor 250. BLUETOOTH transceiver 220 may send and/or receive BLUETOOTH messages, including BLE messages. In some embodiments, BLUETOOTH transceiver 220 may send and/or receive BLUETOOTH messages according to a protocol set forth by the BLUETOOTH Special Interest Group. Wi-Fi transceiver 230 may send and/or receive Wi-Fi messages. In some embodiments, Wi-Fi transceiver 230 may send and/or receive Wi-Fi signals according to an IEEE 802.11 specification. In some embodiments, Wi-Fi transceiver 230 may include a transceiver power controller 232. Transceiver power controller 232 may control power consumption in Wi-Fi transceiver 230 by placing one or more portions of Wi-Fi transceiver 230 into a low-power mode. For example, analog and/or digital portions of Wi-Fi transceiver 230 associated with receiving Wi-Fi messages may be placed in a low-power mode by transceiver power controller 232.

Application processor 250 may be coupled to BLUETOOTH transceiver 220 and Wi-Fi transceiver 230. In some embodiments, application processor 250 receives data from and/or provides data to Wi-Fi transceiver 230 and/or BLUETOOTH transceiver 220. For example, Wi-Fi transceiver 230 may receive Wi-Fi messages from another wireless device (not shown for simplicity) and may provide the received data to the application processor 250. In another example, BLUETOOTH transceiver 220 may receive BLE messages from another wireless device and may provide the received data to the application processor 250.

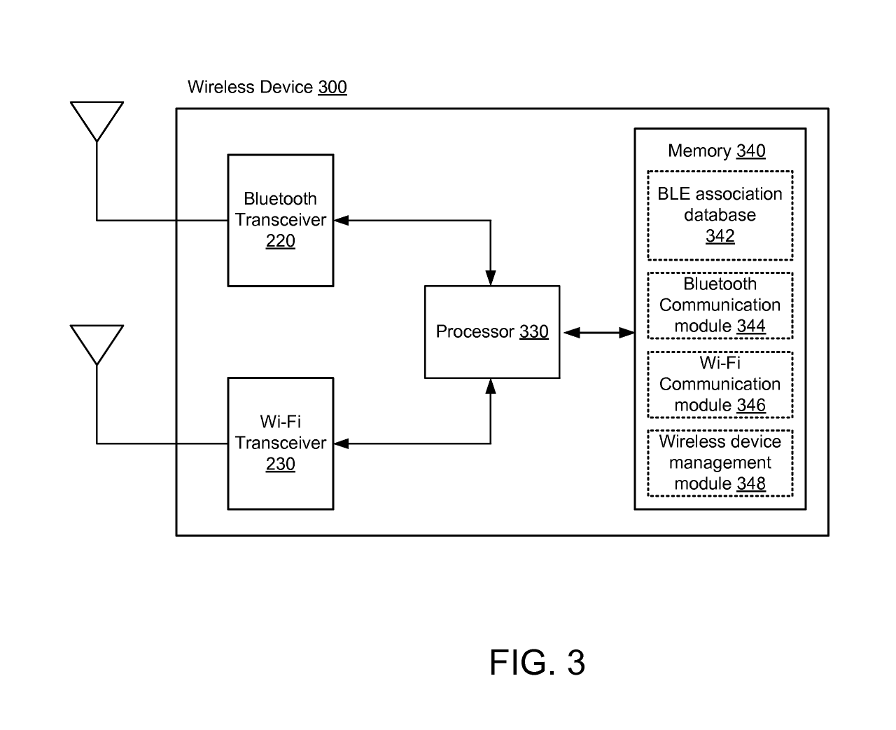

Controller 210 may be coupled to BLUETOOTH transceiver 220, Wi-Fi transceiver 230, and application processor 250. In some embodiments, controller 210 may control operations of BLUETOOTH transceiver 220 and Wi-Fi transceiver 230. For example, controller 210 may cause Wi-Fi transceiver 230 to send Wi-Fi messages including Wi-Fi beacons to other wireless devices. Controller 210 may also cause BLUETOOTH transceiver 220 to send one or more BLE messages to other wireless devices. In some embodiments, controller 210 may cause BLUETOOTH transceiver 220 to send one or more BLE messages synchronized to Wi-Fi beacons sent (e.g., broadcast) by Wi-Fi transceiver 230. The synchronized BLE message (when received by BLUETOOTH transceiver 220 from another wireless device) may cause portions of wireless device 200 to enter or leave a low-power mode. For example, the synchronized BLE message may cause controller 210 to provide a mode_cntl signal 240 to Wi-Fi transceiver 230 and application processor 250. The mode_cntl signal 240 may determine whether Wi-Fi transceiver 230 and/or application processor 250 is in the low-power mode. Operation of controller 210, BLUETOOTH transceiver 220, Wi-Fi transceiver 230, application processor 250, and mode_cntl signal 240 is described below in more detail in conjunction with FIGS. 3-6.

FIG. 3 shows a wireless device 300 that is another embodiment of the AP/P2PGO 101 and/or STA/P2P client 102 of FIG. 1. Wireless device 300 includes BLUETOOTH transceiver 220, Wi-Fi transceiver 230, a processor 330, and a memory 340. BLUETOOTH transceiver 220 and Wi-Fi transceiver 230 may send and receive BLUETOOTH and Wi-Fi messages, respectively, as described above in conjunction with FIG. 2. For example, Wi-Fi transceiver 230 may send Wi-Fi messages, such as Wi-Fi beacons. BLUETOOTH transceiver 220 may send one or more synchronized BLE messages (or other BLUETOOTH signals).

Memory 340 may include a BLE association database 342 that may be used to associate several identification numbers with a particular wireless device. In some embodiments, the wireless device 300 may be identified by a station association identification (AID) number, a station internet protocol address (IP ADDR) and a BLUETOOTH identification number. Table 1 shows example entries in the BLE association database 342.

TABLE 1

| STA Association ID | STA IP ADDR | BLUETOOTH ID |
|---|---|---|
| 0X02 | 192.168.1.33 | 0x03 |
| 0X05 | 192.168.1.70 | 0X04 |

The BLE association database 342 may allow a user and/or program to identify a particular wireless device from at least one of the entries within the BLE association database 342. In some embodiments, data for the BLE association database 342 may be provided by STAs and/or P2P clients of wireless network 100. In other embodiments, data for the BLE association database 342 may be provided by the user through a user operable interface (not shown for simplicity) associated with wireless device 300.

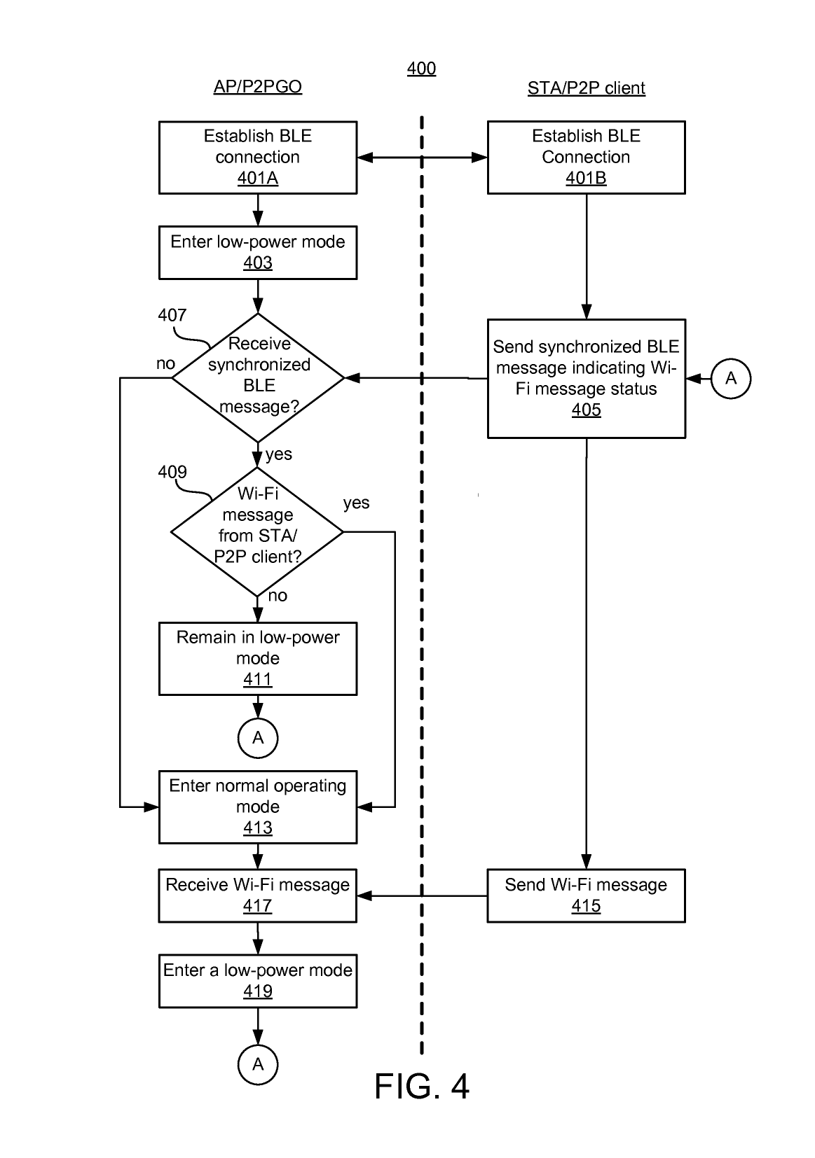

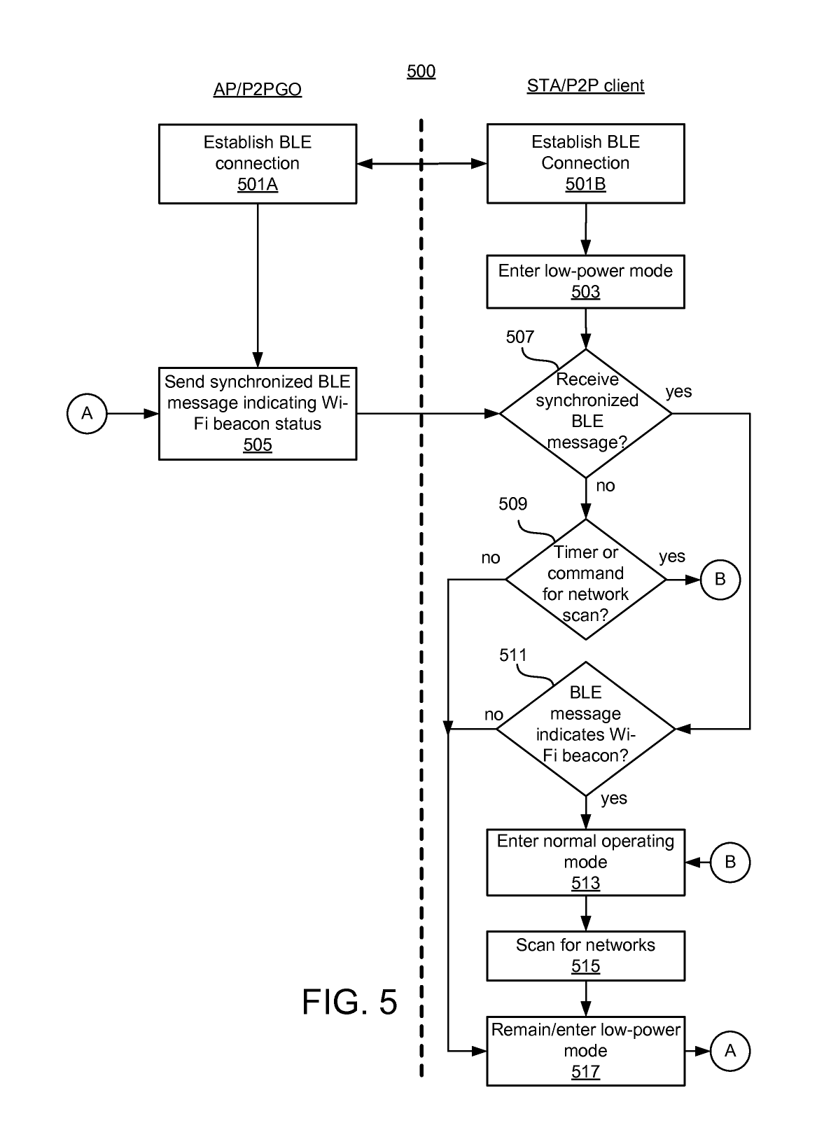

Further, memory 340 may also include a non-transitory computer-readable storage medium (e.g., one or more nonvolatile memory elements, such as EPROM, EEPROM, Flash memory, a hard drive, etc.) that may store the following software modules:
a BLUETOOTH communication module 344 to send and receive BLUETOOTH and BLE messages;
a Wi-Fi communication module 346 to send and receive Wi-Fi messages; and
a Wireless device management module 348 to manage low-power and normal operating modes of wireless device 300.
   Each software module includes program instructions that, when executed by processor 330, may cause the wireless device 300 to perform the corresponding function(s). Thus, the non-transitory computer-readable storage medium of memory 340 may include instructions for performing all or a portion of the operations of FIGS. 4, 5, and/or 6.

Processor 330, which is coupled to BLUETOOTH transceiver 220, Wi-Fi transceiver 230, and memory 340, may be any suitable processor capable of executing scripts or instructions of one or more software programs stored in the wireless device 300 (e.g., within memory 340).

Processor 330 may execute BLUETOOTH communication module 344 to send and/or receive BLUETOOTH messages, including BLE messages. In some embodiments, transmitting and/or receiving BLE messages may consume less power than transmitting and/or receiving BLUETOOTH messages. Some BLE messages may include informational elements that may provide status information regarding a wireless device. For example, a BLE message may include an informational element to indicate that wireless device 300 is sending a Wi-Fi message after the next Wi-Fi beacon. In another example, another BLE message may include an informational element to indicate that a subsequent Wi-Fi message is directed to a particular wireless device. In some embodiments, BLUETOOTH communication module 344 may determine a receive signal strength value associated with received BLUETOOTH and/or BLE messages.

Processor 330 may execute Wi-Fi communication module 346 to send and/or receive Wi-Fi messages, including Wi-Fi beacons. Wi-Fi communication module 346 may also control a power mode of Wi-Fi transceiver 230 through transceiver power controller 232 (see also FIG. 2). For example, Wi-Fi communication module 346 may enter Wi-Fi transceiver 230 into a low-power mode or a normal operating mode based, at least in part, on informational elements included in BLE messages. In some embodiments, Wi-Fi communication module 346 may determine a transmit output power for Wi-Fi transceiver 230 based, at least in part, on the receive signal strength value associated with a BLUETOOTH or BLE message. For example, if the receive signal strength value of the BLUETOOTH or BLE message is relatively high (indicating that the associated wireless device is relatively near), then transmit output power to transmit a Wi-Fi message may be reduced. In some embodiments, transmit output power may be reduced proportionally to decreasing receive signal strength values. In other embodiments transmit output power may be determined based, at least in part, on a look up table indexed by receive signal strength values.

Processor 330 may execute wireless device management module (WDMM) 348 to control at least some operations of BLUETOOTH communication module 344 and/or the Wi-Fi communication module 346. In some embodiments, WDMM 348 may synchronize transmission of some BLE messages with Wi-Fi beacons. For example, WDMM 348 may cause BLUETOOTH communication module 344 to send a synchronized BLE message to one or more wireless devices prior to when Wi-Fi communication module 346 causes Wi-Fi transceiver 230 to send a Wi-Fi beacon. The synchronized BLE message may cause Wi-Fi transceiver 230 to enter or leave a low-power mode as described below in more detail in conjunction with FIGS. 4-6.

FIG. 4 shows an illustrative flow chart depicting an example operation 400 for operating wireless network 100, in accordance with some embodiments. Some embodiments may perform the operations described herein with additional operations, fewer operations, operations in a different order, operations in parallel, and/or some operations differently. In some embodiments, AP/P2PGO 101 may reduce power consumption by entering a low-power mode. For example, while in the low-power mode, portions of AP/P2PGO 101 may be in a low-power state and/or powered off. In response to receiving a BLE message from STA/P2P client 102, AP/P2PGO 101 may enter the normal operating mode (leaving the low-power mode), return power to portions of AP/P2PGO 101, and receive Wi-Fi messages from STA/P2P client 102. Referring also to FIGS. 1 and 2, a BLE connection is first established between AP/P2PGO 101 (401A) and STA/P2P 102 client (401B). In some embodiments, BLUETOOTH transceivers within AP/P2PGO 101 and STA/P2P client 102 may exchange BLUETOOTH transceiver information to establish the BLE connection. For example, the BLE connection may be established using passive scans, user directed scans, through BLUETOOTH messages including advertising messages, or any other technically feasible procedure. In some embodiments, a receive signal strength value of the BLUETOOTH messages may be determined. The receive signal strength value may indicate a proximity of a wireless device. For example, a larger receive signal strength value may indicate a relatively closer wireless device compared to a relatively smaller receive signal strength value. A Wi-Fi message transmitted to a closer wireless device may use less transmit output power.

Next, AP/P2PGO 101 enters a low-power mode (403). In some embodiments, in response to entering the low-power mode, mode_cntl signal 240 may reduce power consumption by turning off a portion of Wi-Fi transceiver 230 included in AP/P2PGO 101. For example, analog and/or digital portions of Wi-Fi transceiver 230 associated with receiving a Wi-Fi message may be placed in a low-power mode and/or turned off. In other embodiments, other portions of AP/P2PGO 101 such as application processor 250 may be placed in the low-power mode.

Next, STA/P2P client 102 sends a synchronized BLE message indicating a Wi-Fi message status to AP/P2PGO 101 (405). In some embodiments, the BLE message is synchronized to a periodic Wi-Fi beacon sent by the AP/P2PGO 101. For example, prior to when AP/P2PGO 101 sends the Wi-Fi beacon, STA/P2P client 102 may send the synchronized BLE message. In some embodiments, the synchronized BLE message may include one or more informational elements indicating Wi-Fi message status. For example, a synchronized BLE message may include an informational element that may indicate whether STA/P2P client 102 has a Wi-Fi message for AP/P2PGO 101. In some embodiments, STA/P2P client 102 may determine a receive signal strength value associated with the synchronized BLE message or a BLE acknowledgment message (possibly sent by AP/P2PGO 101 in response to receiving the synchronized BLE message). The receive signal strength value may be used to determine a transmit output power of a Wi-Fi message transmitted by STA/P2P client 102 to AP/P2PGO 101.

Next, AP/P2PGO 101 determines if the synchronized BLE message is received (407). Since the BLE message is synchronized (in some embodiments, synchronized to the Wi-Fi beacon), the AP/P2PGO 101 may predict when the BLE message may be received. If the synchronized BLE message is received, then AP/P2PGO 101 may determine if the synchronized BLE message indicates that STA/P2P client 102 has a Wi-Fi message for AP/P2PGO 101 (409). In some embodiments, the AP/P2PGO 101 may determine if the synchronized BLE message includes an informational element indicating that STA/P2P client 102 has a Wi-Fi message for AP/P2PGO 101. In some other embodiments, the AP/P2PGO 101 may determine a receive signal strength value associated with the received synchronized BLE message. The receive signal strength value may be used to determine a transmit output power of a Wi-Fi message transmitted by AP/P2PGO 101 to STA/P2P client 102. If the synchronized BLE message indicates that STA/P2P client 102 does not have a Wi-Fi message, then AP/P2PGO 101 remains in the low-power mode (411). Thus, AP/P2PGO 101 may continue to reduce power consumption because there is no Wi-Fi message to receive from STA/P2P client 102. Operations proceeds to 405.

If the synchronized BLE message indicates that STA/P2P client 102 has a Wi-Fi message for AP/P2PGO 101 (as tested at 409), then AP/P2PGO 101 enters the normal operating mode (413). In some embodiments, in response to entering the normal operating mode, mode_cntl signal 240 may return power to application processor 250 and/or portions of Wi-Fi transceiver 230 that may have been previously in a low-power mode. For example, analog and digital portions of Wi-Fi transceiver 230 associated with receiving Wi-Fi messages may return to their operational modes.

Next, STA/P2P client 102 sends the Wi-Fi message to AP/P2PGO 101 (415). For example, STA/P2P client 102 may send data through a Wi-Fi message to AP/P2PGO 101. In some embodiments, the transmit output power associated with the Wi-Fi message may be based, at least in part, on a receive signal strength value associated with a BLE message received from AP/P2PGO 101. For example, a relatively low transmit output power may be used when a relatively high receive signal strength value is determined. In another example, a relatively high transmit output power may be used when a relatively low receive signal strength value is determined. Next, AP/P2PGO 101 receives the Wi-Fi message from STA/P2P client 102 (417). For example, AP/P2PGO 101 may receive data through a Wi-Fi message from STA/P2P client 102. Next, AP/P2PGO 101 may return to the low-power mode (419). In some embodiments, AP/P2PGO 101 may return to the low-power mode to reduce power consumption. Operations proceed to 405.

If AP/P2PGO 101 does not receive the synchronized BLE message (as tested at 407), then operations proceed to 413, and the AP/P2PGO 101 enters the normal operating mode. If the synchronized BLE message is not received (because of, for example, noise or interference present when trying to receive the synchronized BLE message), then AP/P2PGO 101 may enter the normal operating mode as a precaution so as not to miss Wi-Fi traffic that may be sent to AP/P2PGO 101. Since the BLE message is synchronized, a missing (e.g., not received) BLE message may be relatively easy to detect.

FIG. 5 shows an illustrative flow chart depicting another example operation 500 for operating wireless network 100, in accordance with some embodiments. Operation 500 may allow STA/P2P client 102 to reduce power consumption by not performing network scans when known networks are out of range and/or an AP associated with known networks is turned off, in a low-power mode, or otherwise unavailable. First, a BLE connection is established between AP/P2PGO 101 (501A) and STA/P2P client 102 (501B). The BLE connection may be established in a manner similar to 401A and 401B described above in FIG. 4. Next, STA/P2P client 102 enters the low-power mode (503). For example, STA/P2P client 102 may enter the low-power mode when Wi-Fi beacons are no longer received. In some embodiments, in response to entering the low-power mode, mode_cntl signal 240 may cause STA/P2P client 102 to reduce power consumption by not performing network scans (e.g., scanning for networks). In other embodiments, other portions of STA/P2P client 102 may be placed in a low-power mode and/or turned off. For example, application processor 250 may be placed in a low-power mode.

Next, AP/P2PGO 101 sends a synchronized BLE message to STA/P2P client 102 indicating a Wi-Fi beacon status (505). As described above in FIG. 4, the BLE message may be synchronized to the periodic Wi-Fi beacon sent by the AP/P2PGO 101. The synchronized BLE message may include an informational element indicating Wi-Fi beacon status of AP/P2PGO 101. In one embodiment, the informational element may indicate whether AP/P2PGO 101 is to send the Wi-Fi beacon. For example, if AP/P2PGO 101 is in a low-power mode, then AP/P2PGO 101 may not send the Wi-Fi beacon to reduce power consumption. Therefore, AP/P2PGO 101 may send a BLE message indicating that no Wi-Fi beacon is being sent. Thus, STA/P2P client 102 may also reduce power consumption by not scanning for the (missing) Wi-Fi beacon.

Next, STA/P2P client 102 determines if the synchronized BLE message from AP/P2PGO 101 is received (507). As described above, since the BLE message is synchronized, the STA/P2P client 102 may predict when the BLE message may be received. If the BLE message is not received (because, for example, the AP/P2PGO 101 is out of range or in a low-power mode), then STA/P2P client 102 determines if a timer or a user initiates a network scan (509). In some embodiments, a timer may periodically initiate a network scan. For example, STA/P2P client 102 may have entered a new network and the user may want to connect to the new network. By periodically (e.g., under timer control) performing a network scan, new networks may be discovered while still reducing power consumption. In another example, the user may want to initiate a network scan because the user is aware that STA/P2P client 102 has entered a new network area. In one embodiment, if the STA/P2P client 102 is a smart phone, then the user may initiate a network scan by activating the smart phone display.

If a timer or a user initiates a network scan (as tested in 509), then STA/P2P client 102 enters the normal operating mode (513). In some embodiments, mode_cntl signal 240 may return power to application processor 250. Next, in response to entering the normal operating mode, the mode_cntl signal 240 may be cause STA/P2P client 102 to scan for available networks via Wi-Fi transceiver 230 (515).

Next, STA/P2P client 102 may remain or return to the low-power mode (517). The network scan may be complete, and therefore STA/P2P client 102 may return to the low-power mode to reduce power consumption. In some embodiments, in response to entering the low-power mode, mode_cntl signal 240 may cause STA/P2P client 102 to reduce power consumption by not performing network scans. In other embodiments, mode_cntl signal 240 may cause application processor 250 to enter a low-power mode. Operations proceed to 505.

If a timer or a user does not initiate a network scan (as tested in 509), then operations proceed to 517. The STA/P2P client 102 may continue to reduce power consumption by remaining in the low-power mode. If STA/P2P client 102 determines that the synchronized BLE message is received (as tested at 507), then STA/P2P client 102 determines if the synchronized BLE message indicates that a Wi-Fi beacon is forthcoming (511). For example, an informational element within the synchronized BLE message may indicate that AP/P2PGO 101 is to send a Wi-Fi beacon. If STA/P2P client 102 determines that BLE message indicates that there is a forthcoming Wi-Fi beacon, then operations proceed to 513. If STA/P2P client 102 determines that the synchronized BLE message does not indicate that there is a forthcoming Wi-Fi beacon, then operations proceed to 517.

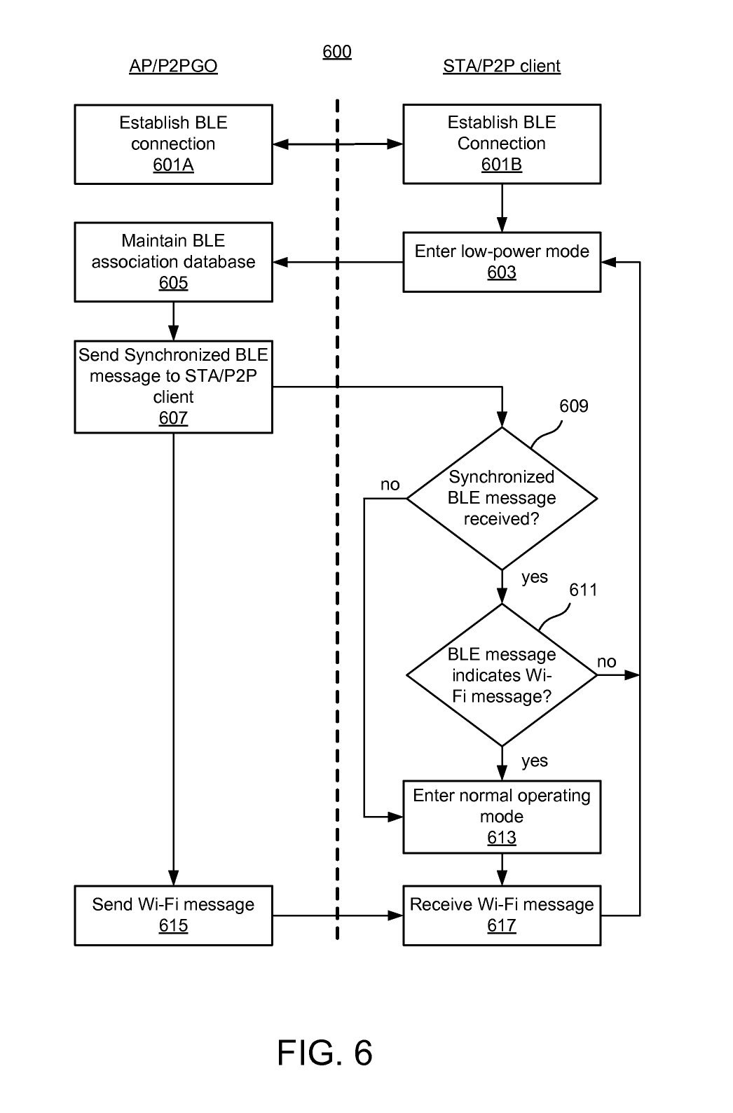

FIG. 6 shows an illustrative flow chart depicting another example operation 600 for operating wireless network 100, in accordance with some embodiments. Operation 600 may allow STA/P2P client 102 to reduce power consumption by maintaining a low-power mode until a BLE message is received indicating a forthcoming Wi-Fi message. For example, STA/P2P client 102 may operate in a low-power mode until a BLE message indicates that a Wi-Fi message, such as an address resolution protocol (ARP) message, is directed to STA/P2P client 102. Address resolution protocol messages may be used to resolve unknown addresses that may be requested by a wireless device. The address resolution protocol message may be sent to particular wireless devices. In some embodiments, AP/P2PGO 101 may determine which STA/P2P client is to receive the Wi-Fi message based, at least in part, on BLE association database 342 described above in conjunction with FIG. 3.

First, a BLE connection is established between AP/P2PGO 101 (601A) and STA/P2P 102 client (601B). The BLE connection may be established in a manner similar to 401A and 401B described above in FIG. 4.

Next, STA/P2P client 102 enters the low-power mode (603). In some embodiments, in response to entering the low-power mode, the mode_cntl signal 240 may reduce power consumption of STA/P2P client 102 by turning off a portion of Wi-Fi transceiver 230. For example, analog and digital portions of Wi-Fi transceiver 230 associated with receiving and/or sending Wi-Fi messages may be placed in a low-power mode via mode_cntl signal 240. In other embodiments, other portions of STA/P2P client 102 may be placed in a low-power mode and/or turned off. For example, application processor 250 may also be placed in a low-power mode.

Next, AP/P2PGO 101 maintains BLE association database 342 (605). As described in Table 1 above, in some embodiments, BLE association database 342 may associate a station association identification (AID) number, a station internet protocol address, and a BLUETOOTH identification number with a STA/P2P client. Thus, AP/P2PGO 101 may identify a particular STA/P2P client through BLE association database 342.

Next, AP/P2PGO 101 sends a synchronized BLE message to STA/P2P client 102 (607). As described above, in some embodiments, the BLE message may be synchronized to the periodic Wi-Fi beacons sent by the AP/P2PGO 101. A recipient of the synchronized BLE message may be determined based, at least in part, on BLE association database 342. For example, AP/P2PGO 101 may have a directed Wi-Fi message, such as an address protocol resolution message, for a particular STA/P2P client 102. AP/P2PGO 101 may determine which particular STA/P2P client 102 receives the directed Wi-Fi message using BLE association database 342. In another example, the directed Wi-Fi message may be any technically feasible unicast or multi-cast Wi-Fi message. In some embodiments, the synchronized BLE message may include an informational element indicating that a Wi-Fi message is forthcoming for the STA/P2P client 102 based on the BLE association database 342.

Next, STA/P2P client 102 determines if the synchronized BLE message from AP/P2PGO 101 is received (609). Since the BLE message is synchronized and periodic, the STA/P2P client 102 may predict when the synchronized BLE message may be received. If the synchronized BLE message is received, then STA/P2P client 102 determines if the BLE message indicates that a Wi-Fi message is forthcoming from AP/P2PGO 101 (611). In some embodiments, STA/P2P client 102 may determine whether the BLE message includes an informational element to indicate that the Wi-Fi message is forthcoming. If the BLE message indicates that a Wi-Fi message is forthcoming, then STA/P2P client 102 enters the normal operating mode (613). In some embodiments, in response to entering the normal operating mode, mode_cntl signal 240 may cause portions of STA/P2P client 102 to receive power. For example, through mode_cntl signal 240, the normal operating mode may return full power to portions of Wi-Fi transceiver 230 that may have previously been in a low-power mode. In another example, mode_cntl signal 240 may return full power to application processor 250.

Next, AP/P2PGO 101 may send the Wi-Fi message to STA/P2P client 102 (615). In some embodiments, the Wi-Fi message may include an address resolution protocol message for STA/P2P client 102. In other embodiments, the Wi-Fi message may include any feasible unicast or multicast Wi-Fi message. Next, STA/P2P client 102 receives the Wi-Fi message from AP/P2PGO 101 (617). Operations proceed to 603.

If the synchronized BLE message does not indicate that a Wi-Fi message is forthcoming (as tested at 611), then operations proceed to 603. Since there is no forthcoming Wi-Fi message, STA/P2P client 102 may continue to reduce power consumption by remaining in the low-power mode.

If synchronized BLE message is not received (as tested at 609), then operations proceed to 613. In some embodiments, the synchronized BLE message may not be received due to noise or interference. However, since the BLE message is synchronized, a missing (e.g., not received) BLE message may be relatively easy to determine. To ensure that STA/P2P client 102 may receive any Wi-Fi messages that may be sent, STA/P2P client 102 may enter the normal operating mode as described above.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of receiving a Wi-Fi message at a first wireless device, the method comprising:
establishing a BLUETOOTH low energy (BLE) connection with a second wireless device;
operating the first wireless device in a low-power mode;
receiving a BLE message from the second wireless device;
leaving the low-power mode and entering a normal operating mode based, at least in part, on the received BLE message; and
receiving a Wi-Fi message from the second wireless device.

2. The method of claim 1, further comprising:
generating a mode control signal based, at least in part, on the received BLE message, wherein assertion of the mode control signal reduces power consumption of the first wireless device.

3. The method of claim 1, wherein the BLE message is synchronized to a Wi-Fi beacon.

4. The method of claim 3, wherein leaving the low-power mode and entering the normal operating mode further comprises determining that the synchronized BLE message is not received.

5. The method of claim 1, further comprising:
determining a transmit output power for a Wi-Fi message transmitted from the first wireless device based, at least in part, on a receive signal strength value of the BLE message received from the second wireless device.

6. The method of claim 1, further comprising:
determining a receive signal strength value of the BLE message received from the second wireless device.

7. The method of claim 1, wherein the first wireless device is a peer-to-peer group owner and the second wireless device is a peer-to-peer client of a Wi-Fi network operating in an ad hoc or peer-to-peer mode.

8. The method of claim 1, wherein the BLE message comprises an informational element indicative of the Wi-Fi message from the second wireless device for the first wireless device.

9. A method of scanning for a Wi-Fi network at a first wireless device, the method comprising:
establishing a BLUETOOTH low energy (BLE) connection with a second wireless device;
operating the first wireless device in a low-power mode;
receiving a BLE message from the second wireless device;
leaving the low-power mode and entering a normal operating mode based, at least in part, on the received BLE message; and
scanning for the Wi-Fi network.

10. The method of claim 9, further comprising:
generating a mode control signal based, at least in part, on the received BLE message, wherein assertion of the mode control signal reduces power consumption of the first wireless device.

11. The method of claim 9, wherein the BLE message is synchronized to a Wi-Fi beacon.

12. The method of claim 11, wherein leaving the low-power mode and entering the normal operating mode further comprises:
determining that the synchronized BLE message is not received; and
receiving a command to scan for the Wi-Fi network.

13. The method of claim 12, wherein the command to scan for the Wi-Fi network comprises determining that a user activates a display in the first wireless device.

14. The method of claim 9, wherein the BLE message comprises an informational element indicative of a Wi-Fi beacon broadcast from the second wireless device.

15. The method of claim 9, wherein operating the first wireless device in the low-power mode comprises powering down a Wi-Fi transceiver of the first wireless device.

16. The method of claim 9, wherein the first wireless device is a peer-to-peer client and the second wireless device is a peer-to-peer group owner of a Wi-Fi network operating in an ad hoc or peer-to-peer mode.

17. A method of operating a first wireless device, the method comprising:
establishing a BLUETOOTH low energy (BLE) connection with a second wireless device;
maintaining an association database at the first wireless device; and
sending a synchronized BLE message to the second wireless device, based at least in part, on the association database.

18. The method of claim 17, wherein the association database comprises at least one of a station association identification number, a station internet protocol address and a BLUETOOTH identification number associated with the second wireless device.

19. The method of claim 17, wherein the synchronized BLE message is synchronized to a Wi-Fi beacon from the first wireless device.

20. The method of claim 17, further comprising sending a Wi-Fi message to the second wireless device, wherein the Wi-Fi message comprises an address resolution protocol message.
